(19) United States
(12) Patent Application Publication
(10) Pub. No.: US 2023/0138822 A1
(43) Pub. Date: May 4, 2023

(54) METHOD FOR MAKING A FERMENTED WHEY PROTEIN PRODUCT

(71) Applicant: GLANBIA NUTRITIONALS LIMITED, Kilkenny (IE)

(72) Inventors: Melinda MOSS, Twin Falls, ID (US); Brent PETERSEN, Twin Falls, ID (US); Niels PALMER, Twin Falls, ID (US)

(73) Assignee: GLANBIA NUTRITIONALS LIMITED, Kilkenny (IE)

(21) Appl. No.: 17/979,736

(22) Filed: Nov. 2, 2022

Related U.S. Application Data
(63) Continuation of application No. 15/567,054, filed on Oct. 16, 2017, now abandoned.
(60) Provisional application No. 62/148,728, filed on Apr. 16, 2015.

(51) Int. Cl. A23C 21/02; A23L 33/19; A23J 1/20; A23J 3/34

(52) U.S. Cl. CPC A23C 21/02; A23L 33/19; A23J 1/205; A23J 3/343; A23V 2002/00

(57) ABSTRACT

Disclosed is a method for producing a fermented whey protein product with improved stability, which can be incorporated into liquids such as beverag,es, or foods such as solid or semi-solid foods. In foods such as protein bars, the fermented whey protein product can decrease hardening over time and improve shelf-life. Also disclosed is a method for producing hydrolyzed whey protein with improved flavor.

This application claims the benefit of priority of U.S. Provisional Application No. 62/148,728, filed Apr. 16, 2015.

### FIELD OF THE INVENTION

The invention relates to methods for producing whey protein products having improved properties. More specifically, the invention relates to whey protein products that are produced as a result of microbial fermentation of whey protein.

### BACKGROUND OF THE INVENTION

Whey is the serum fraction that remains after casein is precipitated from milk during the manufacture of cheese. According to the United States Dairy Export Council, liquid whey “typically contains 93 percent water, 0.8 percent protein, 0.3 percent fat, 4.8 percent lactose and 0.5 percent ash. Liquid whey is made into a variety of commercial ingredients from dried whey (13 percent protein) to whey protein concentrates (25 to 89 percent protein) and whey protein isolates (>90 percent protein).” (Burrington, K. J. Technical Report: Sensory Properties of Whey Ingredients. U.S. Dairy Export Council, 2012.) Whey protein concentrates (WPCs) are labeled according to their protein concentrations, which generally range from 25 to 80 percent (e.g., WPC80). To obtain a 35% protein WPC, the liquid whey has to be concentrated about 5-fold, resulting in total solids of about 8%. Concentration by ultrafiltration to a level of 25- to 30-fold produces WPC80 (80% protein), with a total solids content of 25%.

Whey protein concentrates have both desirable nutritional and functional properties, and are widely used as ingredients in foods such as, for example, frozen desserts, confectionaries, coffee creamers, spreads, whipped foams, baked goods, and processed meats. The properties of WPC that are beneficial in food manufacturing include solubility, emulsification, water binding, gelation, and foaming.

Polysaccharides, such as pectin and carboxymethyl cellulose, for example, form complexes with whey proteins, changing their functional properties. Various polysaccharides, such as dextran sulfate and λ-carrageenan, lower the degree of heat-induced aggregation in whey proteins by forming protein-polysaccharide complexes.

Exopolysaccharides (EPS) synthesized by microbial cells have also been determined to affect the properties of whey protein isolates and whey protein concentrates. Exopolysaccharides vary according to the microorganisms that produce them. Some are neutral, but many are polyanionic due to the presence of either uronic acids (e.g., d-glucuronic acid, d-galacturonic, d-mannuronic acid), ketal-linked pyruvate, or inorganic residues such as phosphate or sulphate. A small percentage of EPS are polycationic. Deep et al. discovered that adding exopolysaccharides to whey protein by the addition of a small amount of fermented whey protein concentrate (WPC) enhanced the functional properties of the WPC, which formed stronger gels that held more water and had less denatured protein after the spray-drying process (Deep G, Hassan A N, Metzger L. Exopolysaccharides modify functional properties of whey protein concentrate. J Daily Sci. 2012; 95(11):6332-6338).

However, the types of bacteria that are generally relied upon to produce fermentation products have nutritional and growth requirements that affect how efficiently fermentation proceeds, how much exopolysaccharide is produced, etc. For example, Leh and Charles demonstrated that Lactobacillus bulgaricus—driven fermentation was significantly more efficient in the presence of a significant amount of hydrolyzed whey protein (Leh and Charles, The effect of whey protein hydrolyzates on the lactic acid fermentation, Journal of Industrial Microbiology, 4 (1989) 71-75). Briczinski and Roberts noted that “[w]hey and whey permeate lack sufficient low molecular weight nitrogen, which presents a challenge to the growth of many industrial microorganisms, so they often require supplementation.” (Briczinski, E. P. and Roberts, R. F., Production of an Exopolysaccharide-Containing Whey Protein Concentrate by Fermentation of Whey, J. Dairy Sci. 85:3189-3197.) Their approach was to utilize a first step of enzymatic hydrolysis to produce a partially-hydrolyzed WPC for the fermentation. The bacteria did produce exopolysaccharide, but the WPC in the WPC/exopolysaccharide product exhibited decreased solubility as compared to that of standard WPC, leading them to observe that “[w]hile it is possible to manufacture an EPS-containing WPC, an alternate means of inactivating the enzyme would be required to minimize the thermal exposure of the proteins.”

Supplementation adds additional expense to the process of producing a whey protein product in conjunction with exopolysaccharide. Hydrolyzing whey protein to produce a sufficient amount of hydrolyzed protein to promote the growth of the bacteria resulted in a method which produced a whey protein product with lower solubility. For some uses, it is desirable to produce a product that comprises little to no hydrolyzed whey protein. Fermentation methods such as those described by Deep, Briczinski, and Leh have utilized liquid whey or a whey protein concentrate having a lower protein content than what may be desirable to produce large quantities of whey protein products using fermentation. Processing significant quantities of whey protein/exopolysaccharide products utilizing fermentation media of lower protein content increases the amount of processing that must be done to produce large amounts of exopolysaccharide-associated whey proteins. What are needed are better methods for producing fermentation products that utilize the beneficial properties of EPS to improve whey protein products, and improved products made by those methods.

### SUMMARY OF THE INVENTION

The invention relates to a method that can be used to produce whey protein concentrates with increased stability and improved formulation properties and products produced by the method. The method, in certain aspects, can also be used to produce hydrolyzed whey proteins with increased flavor and reduced bitterness. The method comprises admixing a lactose source selected from the group consisting of milk permeate, lactose, and combinations thereof with whey protein at a ratio of from about 1:3 to about 1:10 of lactose source to whey protein to form an aqueous admixture having a solids content of from about 10 to about 30% (w/v); adding at least one microbial inoculum to the aqueous admixture; and processing the aqueous admixture to which the at least one microbial inoculum has been added under conditions that promote microbial fermentation to produce a whey protein fermentation product. In various aspects, the whey protein fermentation product is spray-dried upon completion of the desired level of fermentation. In various aspects, the step of processing the aqueous admixture is performed without intermittent or continuous stirring. In other aspects, it may be performed with gentle agitation. In various aspects, the whey protein is selected from the group consisting of whey protein concentrate, whey protein isolate, and combinations thereof. If whey protein concentrate is selected as a whey protein source, it can be selected from the group consisting of whey protein concentrates of from about 40 to about 85% protein (w/w), and combinations thereof. In some aspects of the invention, the whey protein source can also be liquid whey to which additional whey protein has been added by the addition of whey protein products selected from the group consisting of whey protein concentrate, whey protein isolate, and combinations thereof.

In some embodiments of the method of the invention, the microbial inoculum is provide as an inoculum of at least one bacterial strain that produces a ropy exopolysaccharide. In various aspects of the method, the processing time can be from about 6 to about 8 hours. In some aspects, the processing time can be at least about 8 hours.

In various aspects of the invention, the method comprises the additional step of adding at least one proteolytic enzyme to the aqueous admixture prior to, concurrently with, after the step of adding the microbial inoculum to hydrolyze—or partially hydrolyze—the protein during the fermentation process. In some aspects of the invention, the whey protein fermentation product comprises whey protein in combination with the ropy exopolysaccharide produced by the microbial inoculum. In other aspects, the whey protein fermentation product comprises a hydrolyzed whey protein product having improved flavor and reduced bitterness as compared to hydrolyzed whey protein products processed by conventional methods.

### BRIEF DESCRIPTION OF THE DRAWINGS

FIG. 1 is a graph that illustrates the rate of hardening of protein bar products made with products made by the method of the invention. Whey protein concentrate products made by fermenting the whey protein concentrate for a period of 4 hours or a period of 6 hours, followed by co-drying the fermented protein with the exopolysaccharide produced by the bacteria used to produce the fermentation, produce bar products with reduced hardness, and generally increased shelf life, as compared to those products made with whey protein concentrate that has not been fermented. Hardness is indicated on the y-axis and time is indicated on the x-axis. The control is a bar made with unfermented whey protein.

### DETAILED DESCRIPTION

The inventors have developed a method that improves the stability, smoothness, mouthfeel, flavor, and other similar desirable characteristics of whey protein products such as, for example, whey protein concentrates and whey protein isolates for use as an ingredient in a variety of foods, beverages, supplements, etc. Generally, the method does not require the addition of, or the production of, hydrolyzed protein to provide a nitrogen source for the exopolysaccharide-producing bacteria. While hydrolyzed protein may be added or utilized, it is not required for functionality or optimization of the method.

The invention relates to a method that can be used to produce whey protein concentrates with increased stability and improved formulation properties. By adding at least one proteolytic enzyme to the fermentation mix so that enzymatic hydrolysis can occur during the fermentation process, the method can alternatively be used to produce hydrolyzed whey proteins with increased flavor and reduced bitterness. The method comprises admixing a lactose source selected from the group consisting of milk permeate, lactose, and combinations thereof with whey protein at a ratio of from about 1:3 to about 1:10 of lactose source to whey protein to form an aqueous admixture having a solids content of from about 10 to about 30% (w/v); adding at least one microbial inoculum to the aqueous admixture; and processing the aqueous admixture to which the at least one microbial inoculum has been added under conditions that promote microbial fermentation to produce a whey protein fermentation product. In various aspects, the whey protein fermentation product is spray-dried upon completion of the desired level of fermentation.

In various aspects, the step of processing the aqueous admixture is performed without intermittent or continuous stirring. In other aspects, it may be performed with gentle agitation. For example, to produce a whey protein concentrate comprising whey protein and bacterial exopolysaccharide by the method of the invention, it is advisable to perform the fermentation process without intermittent or continuous stirring. To produce a hydrolyzed whey protein product by the method of the invention, it is advisable to provide gentle agitation to promote contact between the one or more enzymes (proteases) and the protein. In various aspects of the method, the processing time can be from about 6 to about 8 hours, from 3 to about 8 hours, from about 4 to about 6 hours, etc. In some aspects, the processing time can be at least about 3 hours. Processing time can be readily selected by those of skill in the art according to the target product that is desired as the result of the use of the method, the degree of hydrolysis desired, etc.

The term “whey protein fermentation product” means a whey protein product that has been subjected to fermentation conditions as provided by the method of the invention. “Microbial inoculum” means an inoculum comprising a pure or mixed culture of one or more microorganisms. The microbial inoculum should be selected to promote fermentation and can also be selected, if desired, to produce certain desirable products, such as bacterial exopolysaccharides, for example. Appropriate fermentation conditions (e.g., time, temperature, etc.) are known to those of skill in the art and can be readily selected according to the microbial inoculum chosen for use in the method. “Processing” means performing the various steps involved in fermentation methods, which are known to those of skill in the art of dairy protein processing and fermentation technology, and selected by those of skill in the art as appropriate for use in the method, such as, for example, heating the admixture to a temperature suitable for promotion of bacterial fermentation, holding the admixture at a desired temperature, mixing, agitating, allowing to sit without mixing, etc.

In various aspects, the whey protein is selected from the group consisting of whey protein concentrate, whey protein isolate, and combinations thereof. If whey protein concentration is selected as a whey protein source, it can be selected from the group consisting of whey protein concentrates of from about 40 to about 85% protein (w/w), and combinations thereof. In some aspects of the invention, the whey protein source can also be liquid whey to which additional whey protein has been added by the addition of whey protein products selected from the group consisting of whey protein concentrate, whey protein isolate, and combinations thereof. In some embodiments of the method of the invention, the microbial inoculum is provide as an inoculum of at least one bacterial strain that produces a ropy exopolysaccharide.

In various aspects of the invention, the method comprises the additional step of adding at least one proteolytic enzyme to the aqueous admixture prior to, concurrently with, after the step of adding the microbial inoculum to hydrolyze the protein during the fermentation process. The combination of fermentation and hydrolysis provides a synergistic effect, producing hydrolyzed protein with desirable flavor profiles and decreased bitterness.

Production of whey protein fermentation products that comprise whey protein in combination with microbial polysaccharide (e.g., bacterial exopolysaccharide) can be readily accomplished by adding to the admixture at least one microbial inoculum (e.g., bacteria, yeast, etc.) that produces a “ropy” exopolysaccharide (EPS) to increase the ropy texture of the protein/EPS complexes produced by the method. The inventors have determined that the desired composition and effect is best achieved when the fermentation is done without continuous or intermittent mixing. Stirring to incorporate the microbial inoculum(s) after the whey and milk permeate or lactose have been pasteurized is recommended, but no additional stirring should be done during the fermentation process.

According to the U.S. Dairy Export Council, “[o]ne of the unique properties of whey protein is good solubility in water over a wide range of pH (from pH 2 to 9), which is important for many beverage applications. One challenge in formulating with whey protein is maintaining solubility during heat processing. A number of methods have been investigated for improving stability of whey proteins, including controlling the size of protein aggregates by the addition of sugar (e.g., glycerol, sorbitol), mineral chelation, and ultra-sonication, as well as controlling protein aggregation using molecular chaperones, enzymatic hydrolysis, electrostatic repulsion, conjugation with carbohydrates, protein encapsulation, and formation of soluble aggregates. One U.S. Dairy Export Council publication states that “[b]everages probably pose the greatest challenge for protein stability due to the high concentrations of protein that some developers hope to achieve. One of the most important steps in achieving good stability is hydration of the whey protein ingredient . . . Best practices for hydration include mixing the whey protein ingredient in water that is less than 60 C with a high-speed mixer and then allowing the whey to hydrate with slow or no agitation for a minimum of 30 minutes prior to heat processing. Continuous mixing with high shear will create foaming and denature the whey proteins prior to heat treatment. This denaturation will lead to a cloudy or grainy/chalky texture and protein precipitation after heat processing.” (Burrington, K. J., Technical Report: Whey Protein Heat Stability, U.S. Dairy Export Council, 2012.)

Briczinski et al. noted that fermentation required the use of hydrolyzed whey, observing that “[u]nhydrolyzed whey was the only medium that resulted in a decrease in the number of viable cells at the endpoint of the fermentation . . . , and only 0.2 g of cell dry weight per liter of whey was produced, which was statistically less than the cell dry weight increase in the hydrolyzed wheys. The lower lactose consumption, viable cell counts, and net cell dry weight for the unhydrolyzed whey indicated whey was a poor fermentation medium for growth of Lactobacillus buigaricus ssp. delbrueckii RR.” (E. P. Briczinski and R. F. Roberts,

Production of an Exopolysaccharide-Containing Whey Protein Concentrate by Fermentation of Whey, J. Dairy Sci. 85:3189-3197.)

However, the inventors have demonstrated that using intact (i.e., unhydrolyzed) whey protein in the fermentation process, and increasing the protein concentration in the fermentation mix, provides the desired effect in regard to producing a product that has visually “ropy” protein/EPS interaction, resulting in improved mouth feel, and other properties such as, for example, mild flavor and cohesive texture, especially when used in nutritional bar applications. By utilizing higher concentrations of protein, the inventors have eliminated the need for the step of pre-hydrolyzing protein or adding hydrolyzed protein to be utilized in the fermentation process. Therefore, although it is acceptable to add hydrolyzed whey to the fermentation admixture if desired, it is not necessary to do so.

Furthermore, without being bound by theory, the inventors believe that increasing the potential for interaction between whey protein and exopolysaccharide optimizes the desirable attributes of a whey protein product produced by the method. Also, the inventors have found that the bacteria which produce a ropy exopolysaccharide are particularly useful for producing whey protein products with improved properties using the method of the invention. For the purpose of increasing the protein/EPS interaction, the inventors recommend the use of whey protein concentrate (WPC) or whey protein isolate (WPI) having a protein content of from about 40 to about 85 percent. The resulting product can be utilized as an ingredient in a variety of products, including, but not limited to, aqueous beverages, frozen desserts, confectionaries, coffee creamers, spreads, whipped foams, baked goods, protein bars, cereal bars, and processed meats.

According to Wijayanti, et al., “[i]n general, whey protein aggregation involves the interaction of a free —SH group with the S—S bond of cystine-containing proteins such as β-Lg, κ-casein (κ-Csn), α-La, and BSA via —SH/S—S interchange reactions (Considine and others 2007). These protein—protein interactions lead to irreversible aggregation of proteins into protein complexes of varying molecular size depending on the heating conditions and protein composition. Knowledge of ways of inhibiting the formation of these protein complexes is needed in order to minimize the negative practical consequences that may arise.” (Wijayanti, H. B. et al., Stability of Whey Proteins During Thermal Processing: A Review,” Comprehensive Reviews in Food Science and Food Safety (2014) 13: 1235-1251.) The method of the invention provides such a method for inhibiting the formation of those protein complexes and maintaining the solubility of whey protein while promoting other desirable properties, as well.

Milk Permeate is a by-product of the Milk Protein Concentrate (MPC) production process, formed after ultrafiltration of milk to extract protein and fat.

Milk Permeate powder is typically at least 80% lactose, with 3% protein, 9% ash, and trace amount of fat. Milk permeate powder may readily be obtained from a variety of commercial suppliers, such as, for example, Idaho Milk Products, Jerome, Idaho USA. Lactose, a disaccharide derived from galactose and glucose, is a commercially-available white crystalline powder isolated from fresh, sweet whey (Glanbia Nutritionals, Inc., Twin Falls, Idaho USA). It is soluble, has a bland flavor, and is colorless in solution. For the purposes of the present invention, either milk permeate or lactose may be used. Whey protein concentrates (WPC) are made by drying the retentate from the ultrafiltration of whey. They are also commercially available, and may be obtained from a variety of commercial suppliers. The inventors used the WPC products produced by Glanbia Nutritionals, Inc., Twin Falls, Idaho USA (Avonlac® WPC).

Many strains of dairy lactic acid bacteria synthesize extracellular polysaccharides (exopolysaccharides). These may be tightly associated with the cell wall (capsular), or be secreted into the medium as a loose slime (ropy). Milk fermented with ropy EPS-producing (EPS+) lactic acid bacteria generally develops a more viscous texture, and EPS+ strains of Streptococcus thermophilus and Lactobacillus delbrueckii ssp. bulgaricus are often used in yogurt to enhance viscosity and reduce syneresis. (Petersen, B. L. et al., Influence of Capsular and Ropy Exopolysaccharide-Producing Streptococcus thermophilus on Mozzarella Cheese and Cheese Whey, J. Dairy Sci. (2000), 83(9): 1952-1956.) Faber et al. observed that the milk inoculum of S. thermophilus Rs is non-ropy, producing 135 mg/L polysaccharide with an average molecular mass of 2.6×10³ kDa, while the milk inoculum of S. thermophilus Sts is ropy and produces 127 mg/L polysaccharide with an average molecular mass of 3.7×10³ kDa, the difference in molecular mass of the polysaccharide being the primary difference between the ropy and non-ropy strains (E. J. Faber, et al., The Exopolysaccharides Produced by Streptococcus Thermophilus Rs and Sts Have the Same Repeating Unit but Differ in Viscosity of Their Milk Inoculums, Carbohydrate Research (1998), 310(4): 269-276). Microbes (e.g., bacterial strains) that have been identified as producing the ropy exopolysaccharide are commercially available and may be purchased from companies such as Chr. Hansen (Høsholm, Denmark).

Products comprising whey protein and polysaccharides made by the method of the invention offer several significant advantages in terms of desirable formulation properties, but they also reduce or eliminate the need for the use of commercially-available hydrocolloids, such as those shown in Table 1, in products containing whey protein. The addition of hydrocolloids can, in some circumstances, significantly add to the cost of product manufacture. Cost of hydrocolloids can be as much as $25-$30 U.S. Dollars per pound. Many products such as protein bars, for example, may be at least 33 to 35 percent protein. With the amount of hydrocolloid needed generally corresponding to the amount of protein, the use of added hydrocolloid can significantly impact the cost of such high-protein products.

TABLE 1

| | Usage | Mid-Range Usage | Costing | Cost Use Basis |
|---|---|---|---|---|
| Hydrocolloid | Range (%) | for Costing (%) | ($/lb) | (16 oz serving) |
| CMC-3000 | 0.1-0.80 | 0.45 | 4.25 | $0.0211 |
| Xanthan 80 | 0.02-0.30 | 0.16 | 4.40 | $0.0078 |
| Alginate | 0.005-1.00 | 0.50 | 8.25 | $0.0454 |
| Carrageenan, kappa | 0.01-3.00 | 1.50 | 10.00 | $0.1652 |
| Pectin | 0.01-1.00 | 0.50 | 14.00 | $0.0771 |

The use of EPS in whey protein/EPS products of the invention can also have added beneficial health effects. For example, Ruas-Madiedo, et al. noted that EPS produced by Lactobacillus and Bifidobacterium species could antagonize the in vitro toxicity of bacterial pathogens (Ruas-Madiedo, et al., Exopolysaccharides Produced by Lactobacillus and Bifidobacterium Strains Abrogate in vitro the Cytotoxic Effect of Bacterial Toxins on Eukaryotic Cells, J. Appl. Micro. (2010), 109(6): 2079-2086). EPS has also been reported to have a cholesterol-lowering effect, as well as to aid in reducing formation of pathogenic biofilms.

Products made by the method of the invention can also be useful for the purpose of increasing the shelf-life of food products such as, for example, protein bars. High-protein bars are generally made of approximately 20 to 50 percent protein (w/w), with a ratio of 30:30:40 (w/w) of protein, fat, and carbohydrate (usually as syrup) being common. The dough produced from this combination is generally sufficiently malleable to be readily formed into bars that retain their shape during packaging and shipping. However, over time, the bars can harden and become unacceptable to consumers. Two options that have been previously used to address this problem are hydrolyzing the proteins and increasing the hydrophobicity of the proteins. Options such as these, however, add additional steps and costs to the manufacturing process.

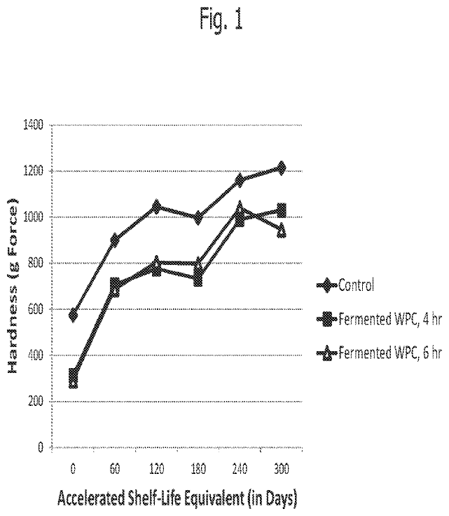

Formulators have observed that the process that produces hardening begins almost immediately, and some propose that hardening is initiated by a phase separation between protein and carbohydrate (McMahon, D. J. et al., Hardening of High-Protein Nutrition Bars and Sugar-Polyol-Protein Phase Separation, J. Food Sci. (2009) 74(6): E312-321). However, as shown on the graph in FIG. 1, hardness is significantly decreased when the whey protein product is made by the method of the invention, with the WPC being fermented for a period of hours (e.g., from about 4 to about 6 hours). The inventors noted that extended fermentation (e.g., overnight) could actually result in increased hardness over time in their own experiments with nutritional bar formulations. Therefore, extended fermentation times may not produce the desired effect when the product is to be used for the purpose of extending shelf life and decreasing hardening over time for food products such as, for example, protein bars. In those cases, shorter fermentation times (e.g., from about 3 to about 8 hours) are recommended.

The inventors have also demonstrated that adding one or more enzymes to promote hydrolysis of the whey protein during fermentation, as opposed to prior to fermentation, produces peptides with increased fermentation flavor with a less pronounced bitter flavor. Peptides made by this method may therefore have, for example, a cheese flavor that is more intense and pronounced, with less bitterness. Without being bound by theory, the inventors believe that the blend of inoculum and enzyme produces a synergistic effect during incubation. The peptides that are formed by enzymatic digestion are generally very bitter, and brothy. Forming the peptides in the presence of the EPS produced during the fermentation may bind up the bitter ends, increasing the flavor while decreasing the associated bitterness. Fermenting the protein in the presence of both bacteria and enzyme, with very mild agitation such as that provided by a water bath shaker, promotes contact between the enzymes and the protein.

### EXAMPLES

### Production of Fermented Whey Protein Concentrate/EPS Product

Twenty percent milk permeate powder (Idaho Milk Products), eighty percent Avonlac® 180 (Glanbia Nutritionals), and 0.25% disodium phosphate were admixed with water at 25% solids (w/v) and pasteurized at 165° F. for 30 seconds (exit temperature 100° F.).

One percent YC-180 (Yo-Flex®, Chr. Hansen), which contains Lactobacillus delbrueckii subsp. bulgaricus, Lactobacillus delbrueckii subsp. lactis, and Streptococcus thermophilus yogurt inoculum was used to inoculate the admixture, and it was incubated for 4-6 hours without stirring (final pH 4.6-5.0). At the end of the incubation period, the solids were spray-dried at an inlet temperature of 240° C. and an outlet temperature of 88-90° C.

Incorporation of Fermented Whey Protein Concentrate/EPS Product into Protein Bars

Corn syrup (47%) shortening (19%) and protein powder (fermented whey protein concentrate/EPS) (34%) were added into a bowl and mixed until a workable dough was formed. The dough was extruded, cut into bars, enrobed in chocolate, and packaged. Hardness testing was performed, and results are shown in Table 2 and FIG. 1. The control is an unfermented whey protein product.

TABLE 2
Hardness (g-Force) Measured During Extended Shelf Life

| | Accelerated Equivalent: | | | | | |
|---|---|---|---|---|---|---|
| | 0 | 60 | 120 | 180 | 240 | 300 |
| | Days | Days | Days | Days | Days | Days |
| Control | 574 | 899 | 1044 | 996 | 1159 | 1213 |
| Fermented | 311 | 705 | 775 | 732 | 989 | 1029 |
| WPC 4 hours | | | | | | |
| Fermented | 289 | 687 | 802 | 797 | 1040 | 945 |
| WPC 6 hours | | | | | | |

Whey Fermented with a Combination of Enzymes and Bacteria

Whey protein concentrate (90%, dry matter basis), 28 percent solids was admixed with lactose permeate (9%, dry matter basis, 25 percent solids by blending the liquids together. The blended liquid was heated to 150 degrees Fahrenheit for 15 minutes, then cooled to 120 degrees Fahrenheit. Inoculum was added at 1%, the solution was mixed well, and 0.25% Debitrase HYW20 (DuPont Nutrition and Health) was added. The solution was mixed well, covered, and placed in a water bath set to 125 degrees Fahrenheit, with shaker on. The mixtures was allowed to incubate for 8 hours, at which time the set was broken and the product was dried by spray-drying.

TABLE 3

| Base | Incubation | | Inoculum | Enzyme | Flavor |
|---|---|---|---|---|---|
| (DMB) | Time | pH | Used | Used | Profile |
| 90% WPC | 8 hours | 4.1 | Chris Hansen | None | Flavor more |
| 9% Lactose | | | LB-H03 | | up-front, does |
| permeate | | | | | not linger. |
| | | | | | Cheesy. |
| 90% WPC | 8 hours | 4.1 | Chris Hansen | HYW-20 | More intense |
| 9% Lactose | | | LB-H03 | | flavor notes. |
| permeate | | | | | Stronger |
| | | | | | cheese flavor. |
| | | | | | Stronger aged |
| | | | | | flavors. |

1. A method comprising:
a) admixing a lactose source selected from the group consisting of milk permeate, lactose, and combinations thereof with unhydrolyzed whey protein at a ratio of from about 1:4 to about 1:10 of lactose source to whey protein to form an aqueous admixture having a solids content of from about 10 to about 30% (w v);
b) pasteurizing the aqueous admixture at about 150° F. to about 165° F. for about 30 seconds to about 15 minutes;
c) adding at least one microbial inoculum, comprisin at least one bacterial strain that produces a ropy exopolysa.cchari de, to the aqueous admixture;
d) processing the aqueous admixture to which the at least one microbial inoculum has been added under conditions that promote microbial fermentation to produce a whey protein fermentation product; and
e) spray-drying the whey protein fermentation product to produce a protein powder.

2. (canceled)

3. The method of claim 1 wherein the step of processing the aqueous admixture is performed without intermittent or continuous stirring.

4. The method of claim 1 wherein the step of processing the aqueous admixture is performed with gentle agitation.

5. The method of claim 1 wherein the whey protein is selected from the group consisting of whey protein concentrate, whey protein isolate, and combinations thereof.

6. The method of claim 5 wherein the whey protein concentrate is selected from the group consisting of whey protein concentrates of from about 40 to about 85% protein (w/w), and combinations thereof.

7. The method of claim 1 wherein the whey protein comprises liquid whey to which additional whey protein has been added by the addition of at least one whey protein product selected from the group consisting of whey protein concentrate, whey protein isolate, and combinations thereof.

8. The method of claim 1 wherein the step of processing provides a fermentation time of from about 3 to about 8 hours.

9-10. (canceled)

11. The method of claim 1 further comprising the additional step of adding at least one proteolytic enzyme to the aqueous admixture prior to, concurrently with, or after the step of adding the microbial inoculum to hydrolyze the whey protein during the fermentation.

12. The method of claim 1, further comprising
f) producing dough for protein bar products comprising the protein powder, wherein the protein bar products have increased shelf life as compared to control protein bar products made from non-fermented whey protein concentrate.

13. The method of claim 1, wherein the step of pasteurizing the aqueous admixture is performed at about 165° F. for about 30 seconds.

14. The method of claim 1, wherein the step of pasteurizing the aqueous admixture is performed at about 150° F. for about 15 minutes, and the admixture is then cooled to about 120° F.
